(19) United States
(12) Patent Application Publication
(10) Pub. No.: US 2021/0259420 A1
(43) Pub. Date: Aug. 26, 2021

(54) MAST ARRANGEMENT FOR A STORAGE AND RETRIEVAL UNIT

(71) Applicant: MIAS Maschinenbau, Industrieanlagen & Service GmbH, Eching (DE)

(72) Inventors: Antonio HOHNHORST, Olching (DE); Martin HOOLE, Munich (DE); Manuel MOTILVA, Germering (DE)

(21) Appl. No.: 17/185,268

(22) Filed: Feb. 25, 2021

(30) Foreign Application Priority Data
Feb. 26, 2020 (DE) 10 2020 202 438.3

(51) Int. Cl. A47B 96/14; B65G 1/04

(52) U.S. Cl. CPC A47B 96/1433; B65G 1/04

(57) ABSTRACT

A mast arrangement for a storage and retrieval unit is disclosed. The mast arrangement includes a mast, which is formed by a front flange plate, two side plates and, a rear flange plate and has a box profile and a substantially rectangular cross section, interface elements, which are each secured in pairs to the side plates and extend in the region of the front flange plate, and a rail for guiding the storage and retrieval unit. The rail is attached to each of the interface element. The interface elements are each provided with a hole, a reinforcement element extending through the hole, and through corresponding holes in the side plates, and are connected on both sides to the relevant interface elements.

The present invention relates to a mast arrangement for a storage and retrieval unit, comprising a mast, which is formed by a front flange plate, two side plates and a rear flange plate and has a box profile and a substantially rectangular cross section, a plurality of interface elements, which are each secured in pairs to the side plates and/or to the front flange plate and which extend in the region of the front flange plate, and a rail for guiding the storage and retrieval unit, the rail being attached to each of the interface elements.

Generic mast arrangements of this kind are known from the prior art. To make them stable and stiff enough to withstand the moments caused by the storage and retrieval unit traveling on them, in known embodiments of said mast arrangements barrier plates are currently positioned inside the hollow profile of the mast at regular distances apart so as to prevent the long flange plates from buckling under locally high stresses at the current position of the lift truck.

However, securing these barrier plates inside the mast is very complex since at least one edge thereof has to be welded after the box profile of the mast has been completely closed. Therefore, openings have to be provided in the side plates of the mast at suitable positions so that the welder can actually reach the intended seam position. However, welding through these openings is also very complex because of the confined working space and necessitates high skill from the welder, meaning that this work cannot be automated or is very difficult to automate. In addition, since the weld start point is predefined in this way, the weld seam may have an unfavorable notch effect.

Therefore, the problem addressed by the present invention is to further develop a mast arrangement for a storage and retrieval unit of the above-described generic type in such a way as to make it simpler to produce than the current configuration and in particular to make it suitable for a welding robot to be used, while simultaneously achieving at least the same high level of stability and stiffness with lower costs.

To solve this problem, in the mast arrangement according to the invention the interface elements of at least one pair of interface elements are each provided with a hole, a reinforcement element extending through said hole, and through corresponding holes in the side plate, and being connected on both sides to the relevant interface elements.

It has been found that by providing at least one reinforcement element in this manner in the region of the interface elements, i.e. at short distances apart close to the front flange plate, it is possible to obtain sufficient local stiffness and reinforcement of the mast such that only a minimal number of barrier plates, if any, are required.

Since the interface elements can be inserted through the holes, which in particular can be formed by drill holes, from the exterior, they are also easily accessible from the exterior and can be connected to the relevant interface elements in a simplified manner. In the process, the interface elements are formed substantially as chocks and the rail can be attached to at least some of said interface elements by a screw connection or by means of lockbolts.

Alternatively or additionally, the securing of at least some of the interface elements to the side plates, and/or the securing of at least some of the reinforcement elements to the interface elements, can be performed by welding, in particular fillet welding.

While it is conceivable in principle to arrange the pairs of interface elements in many different ways, for example again in pairs at relatively short distances apart in the longitudinal direction of the mast followed by a larger distance to the next pair of interface elements, in a particularly simple embodiment the pairs of interface elements can be arranged along the mast at substantially regular distances apart.

In addition, at least one of the reinforcement elements can be formed by a tubular element, in particular by a hollow tube. It goes without saying, however, that other geometric shapes of reinforcement elements are possible, for example canted plates or the like; however, an optimal mast stiffening effect can be obtained with minimal use of materials when using in particular hollow tubes having a circular cross section.

To allow the reinforcement elements to be suitably connected to the interface elements, and in particular to enable the aforementioned welding, the length of at least one of the reinforcement elements can be between 1% and 10% larger than the distance between the side faces, such that the corresponding stiffening element protrudes beyond both sides by a sufficient amount for a connection, for example a weld, but no additional unnecessary materials or space are required.

Additionally, in relation to the present invention, the mast arrangement can further comprise at least one barrier plate, which extends inside the box profile of the mast substantially perpendicularly to the flange plates and the side plates, for example if it turns out that, as a result of this, it is necessary to further stiffen the mast arrangement. In any case, however, the number of these barrier plates can be considerably reduced compared with known mast arrangements from the prior art.

According to a further aspect, the present invention relates to a method for producing a mast arrangement of this kind, comprising the steps of tack-welding the rear flange plate and the two side faces, inserting and subsequently tack-welding the front flange plate, the interface elements and the reinforcement elements, and then welding the tack-welded seams. After this, the rail can then be secured to the interface elements, for example rigidly screwed thereto.

As already indicated above, this method can be implemented with a higher degree of automation in a considerably more efficient way compared with mast arrangement production methods from the prior art; even if at least one barrier plate is still welded in between the tack-welding of the rear flange plate and the two side plates and the insertion and subsequent tack-welding of the front flange plate, the interface elements and the reinforcement elements, at least some of the corresponding welding steps can advantageously be carried out by means of a welding robot.

Further features and advantages of the present invention will become clear from the following description of an embodiment when taken together with the accompanying drawings, in which:

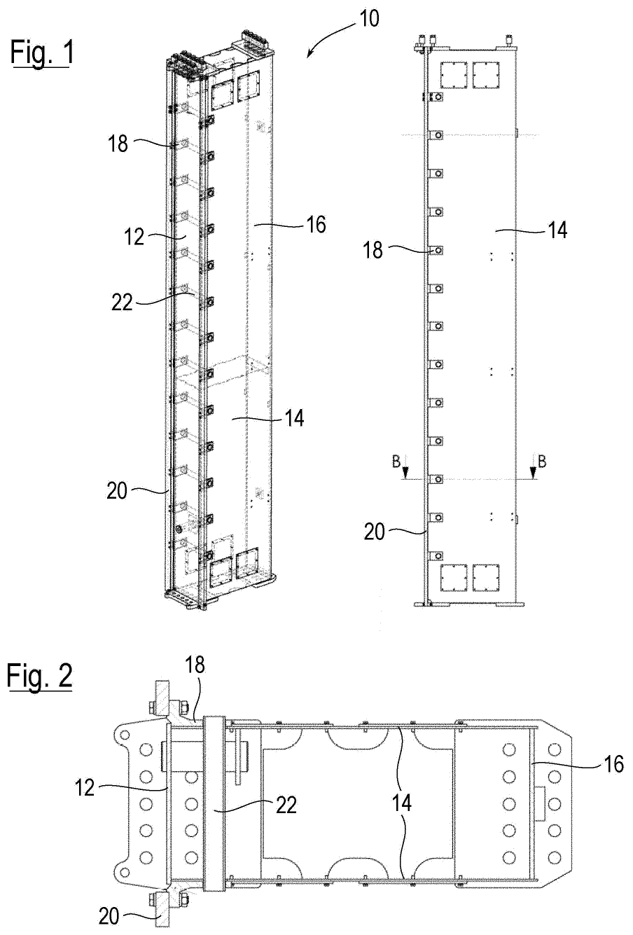

FIG. 1 shows a schematic isometric view and a side view of a storage and retrieval unit according to the invention; and

FIG. 2 is a cross section through the mast arrangement from FIG. 1 along sectional plane B from FIG. 1.

FIG. 1 shows two different views of a mast arrangement according to the invention for a storage and retrieval unit, said mast arrangement being denoted in general terms by reference numeral 10. In the process, a mast is formed by a front flange plate 12, two side plates 14 and a rear flange plate 16 and has a box profile and a substantially rectangular cross section.

Furthermore, interface elements 18 are each secured to the side plates 14 in pairs and opposite one another along the length of the mast, said interface elements extending in the region of the front flange plate 12 and a rail 20 being attached to each of them. By way of example, the interface elements 18 can be formed as forged pieces.

As can be seen in particular from the cross-sectional view from FIG. 2, both the interface elements 18 and the side plates 14 are, at the corresponding points, provided with holes in the form of drill holes, through each of which reinforcement elements 22 in the form of hollow tubes having a circular cross section are inserted. These reinforcement elements 22 are used for locally stiffening the mast in order to absorb the stresses on the flange plates in the region of the current lift truck position on the rail 20. Owing to this measure, the number of barrier plates 24 required inside the mast can be reduced, and so the production of the mast arrangement 10 can be simplified. In particular, the rail 20 can be secured by means of a screw connection or by lockbolts, while the interface elements 18 can be attached to the side plates 14, and the reinforcement elements 22 attached to the interface elements 18, in each case by welding, for example fillet welding.

1. A mast arrangement for a storage and retrieval unit, the mast arrangement comprising:
a mast comprising a front flange plate, two side plates, and a rear flange plate, wherein the mast comprises a box profile and a substantially rectangular cross section;
a plurality of interface elements, secured in pairs to at least one of the side plates or the front flange plate and extending towards the front flange plate; and
a rail for guiding the storage and retrieval unit, the rail attached to each of the interface elements,
wherein each of the interface elements of at least one pair of interface elements includes a hole and a reinforcement element extending through said hole, extending through corresponding holes in the side plates, and connected on both sides to one of the interface elements.

2. The mast arrangement according to claim 1, wherein the rail is attached to at least some of the interface elements by a screw connection or by lockbolts.

3. The mast arrangement according to claim 1, wherein securing at least some of the interface elements to the side plates, or securing at least some of the reinforcement elements to the interface elements, is performed by welding.

4. The mast arrangement according to claim 1, wherein the pairs of interface elements are arranged along the mast at substantially regular distances apart.

5. The mast arrangement according to claim 1, wherein at least one of the reinforcement elements is formed by a tubular element.

6. The mast arrangement according to claim 1, wherein a length of the reinforcement element is between 1% and 10% larger than a distance between the side plates.

7. The mast arrangement according to claim 1, further comprising at least one barrier plate extending inside the box profile of the mast substantially perpendicularly to the flange plates and the side plates.

8. A method for producing a mast arrangement the method comprising:
tack-welding, to a mast, a rear flange plate and two side plates, wherein the mast comprises a box profile and a substantially rectangular cross section, thereby creating tack-welded seams;
inserting, to the mast, and subsequently tack-welding to the mast, a front flange plate, a plurality of interface elements, and a reinforcement element, wherein the plurality of interface elements are attached to a rail and secured in pairs to at least one of the side plates or the front flange plate and extend towards the front flange plate, and wherein the reinforcement element extends through holes provided in each of the interface elements and corresponding holes in the side plates; and
welding the tack-welded seams.

9. The method according to claim 8, further comprising after inserting the front flange plate and before welding the tack-welded seams, welding in at least one barrier plate.

10. The method according to claim 8, wherein welding the tack-welded seams is performed by welding robot.

11. The mast arrangement according to claim 2, wherein at least some of the interface elements are secured to the side plates by welding, or at least one of the reinforcement elements is secured to the interface elements by welding.

12. The mast arrangement according to claim 11, wherein the welding is fillet welding.

13. The mast arrangement of claim 5, wherein the tubular element is hollow.

14. A mast arrangement for a storage and retrieval unit, the mast arrangement comprising:
a mast comprising a front flange plate, a first side plate, a second side plate, and a rear flange plate;
a pair of interface elements comprising a first interface element secured to the first side plate and a second interface element secured to the second side plate, wherein the pair of interface elements extend towards the front flange plate; and
a rail attached to the first interface element and the second interface element, wherein the first interface element and the second interface element each comprise a hole and a reinforcement element extending through the hole and extending through corresponding holes in the side plates.

15. The mast arrangement of claim 14, wherein a length of the reinforcement element is between 1% and 10% larger than a distance between the side plates.

16. The mast arrangement of claim 14, further comprising a box profile and at least one barrier plate extending inside the box profile of the mast substantially perpendicular to the flange plates and the side plates.

17. The mast arrangement of claim 14, wherein at least one of the reinforcement elements formed by a hollow tubular element.
